(19) United States
(12) Patent Application Publication
(10) Pub. No.: US 2013/0315602 A1
(43) Pub. Date: Nov. 28, 2013

(54) OPTICAL TRANSMISSION DEVICE

(71) Applicant: Takefumi Oguma, Tokyo (JP)

(72) Inventor: Takefumi Oguma, Tokyo (JP)

(73) Assignee: NEC CORPORATION, Tokyo (JP)

(21) Appl. No.: 13/983,888

(22) PCT Filed: Dec. 16, 2011
(86) PCT No.: PCT/JP2011/079973

§ 371 Date: Aug. 6, 2013

(30) Foreign Application Priority Data
Feb. 9, 2011 (JP) 2011-026257

(51) Int. Cl. H04J 14/02

(52) U.S. Cl. CPC H04J 14/0201
USPC 398/83

(57) ABSTRACT

The present invention reduces the number of amplifiers and reduces the maximum output of an optical transmission device.

A wavelength selection unit selects and outputs, as a drop signal, any given wavelength of optical signal from an input optical signal. At each wavelength, an amplifier amplifies the drop signal output by the wavelength selection unit. In this case, the number of amplifiers is set lower than the number of wavelengths of the input optical signal. Also, the wavelength selection unit selects a number of wavelengths of drop signals corresponding to the number of amplifiers, and outputs the selected drop signals to the amplifiers at each wavelength.

### TECHNICAL FIELD

The present invention is related to an optical transmission device for conducting, for example, Add/Drop of an optical signal, direction change thereof, and the like, in an optical network.

### BACKGROUND ART

These days WDM (Wavelength Division Multiplexing) network becomes widespread. WDM is one of communication technologies employing an optical fiber, and a system which simultaneously uses a plurality of optical signals, wavelengths of which are different from each other, to use the optical fiber in a multiplexed manner. The WDM network has been applied to a single-degree Point-to-Point, a two-degree ring network, and a multi-degree network in that order.

FIG. 6 illustrates a common optical transmission device. As shown in FIG. 6, an optical transmission device 9000 is configured to include a plurality of optical add-drop multiplexing units 910a to 910d, an aggregator 920, a wavelength selection filter 950, and transponders 960 and 980. The aggregator 920 includes a reception unit 930 and a transmission unit 940.

### Optical Signals

λ1a, λ1b, λ1c and λ1d enter the optical add-drop multiplexing units 910a to 910d, and optical signals λ2a, λ2b, λ2c and λ2d are outputted therefrom, respectively. In following descriptions, if it is not necessary to separately explain each of the optical add-drop multiplexing units 910a to 910d, these are collectively referred to as “optical add-drop multiplexing unit 910” hereinafter. Also, the optical signal 7 λ1a to λ1d are referred to as “optical signal λ1”, and the optical signals λ2a to λ2d are referred to as “optical signal λ2”.

The optical add-drop multiplexing unit 910 includes an optical coupler 911, an optical connecter 912, and a wavelength selectable switch for adding for adding 913. Hereinafter, the wavelength selectable switch for adding for adding 913 is referred to as “WSS for adding 913”. The aggregator 920 includes the reception unit 930 and the transmission unit 940. Each of the optical couplers 911 in the optical add-drop multiplexing units 910a to 910d is connected to the WSSs for adding 913 in all of the optical add-drop multiplexing units 910a to 910d. Thereby, each of the optical add-drop multiplexing units 910a to 910d includes a wavelength cross-connect function.

In the optical add-drop multiplexing unit 910, the optical coupler 911 branches the optical signal λ1, inputs one of the branched signals of the optical signal λ1 to the optical connecter 912, and inputs the other to the WWS for adding 913. One of the branched signals of the optical signal λ1 is outputted, through the optical connecter 912, the reception unit 930, and the wavelength selection filter 950, from the transponder 960 to a client network side.

Another signal enters the WWS for adding 913 from the client network side, through the transponder 980 and the transmission unit 940. The WSS for adding 913 adds the signal inputted from the transmission unit 940 to the other of the branched signals of the optical signal λ1 to output the optical signal λ2.

The reception unit 930 includes an amplifier 931, merging unit 932, and an optical switch 933. The transmission unit 940 includes an amplifier 941, merging unit 942, and an optical switch 943.

The amplifier 931 includes a plurality of amplifiers 931a, 931b, 931c . . . , which amplify optical signals to be inputted to the reception unit 930 at each wavelength, and the amplifier 941 includes a plurality of amplifiers 941a, 941b, 941c . . . , which amplify optical signals to be outputted from the transmission unit 940 at each wavelength. If it is not necessary to separately explain each of the amplifiers 931a, 931b, 931c . . . , and 941a, 941b, 941c . . . , these are collectively referred to as “amplifier 931” and “amplifier 941”, respectively. The number of the amplifiers 931 corresponds to the number of wavelengths of the inputted signals. The merging unit 932 merges the inputted optical signals and the branching unit 942 branches the inputted optical signals. The optical switches 933 and 943 are used in order to select routes for optical signals, for example.

Publication of Japanese Unexamined Patent Application No. 2010-98545 (Patent document 1) discloses, as an example of an optical transmission device, a device for conducting add-drop of an optical signal and route change thereof in an optical transmission network.

### DISCLOSURE OF THE INVENTION

### Problem to be Solved by the Invention

In the optical transmission device 9000, however, the merging unit 932 is arranged in the aggregator 920, and loss (principle loss) occurs due to merging of the optical signals in the merging unit 932. In order to compensate the loss, the optical transmission device 9000 includes the amplifier 931.

In particular, the reception unit 930 needs to directly amplify, at each wavelength, the optical signals inputted from routes of the optical add-drop multiplexing units 910a to 910d using the plurality of amplifiers 931. Since the number of wavelengths of the inputted optical signals correspond to the maximum number of transmission wavelengths, in order to secure an optical output of each wavelength of the inputted optical signals, the maximum output of the amplifier 931 (sum of outputs of the amplifiers 931a, 931b, . . . ) has to be increased, or the number of wavelengths to be housed in the aggregator 920 (i.e. the number of wavelengths merged by the merging unit 932 in the aggregator 920) has to be reduced by compensating the loss (principle loss). At this time, if the maximum output of the amplifier 930 is increased, the optical transmission device 9000 including the aggregator 920 is enlarged and further becomes costly since the size of the amplifier 930 is increased.

In the light of such situation, an object of the invention is to provide an optical transmission device to solve the problem described above.

### Means for Solving the Problem

An optical transmission device of the invention includes a wavelength selection unit for selecting and outputting as a drop signal any given wavelength of optical signal from an input optical signal, and an amplifier for amplifying the drop signal output by the wavelength selection unit at each wavelength, wherein the number of amplifiers is set lower than the number of wavelengths of the input optical signal, and the wavelength selection unit selects a number of wavelengths of drop signals corresponding to the number of amplifiers, and outputs the selected drop signals to the amplifiers at each wavelength.

### Effect of the Invention

The technology related to the invention is capable of reducing the number of the amplifiers and the maximum output of the optical transmission device.

### BRIEF DESCRIPTION OF THE DRAWING

FIG. 1 is a drawing illustrating a configuration of an optical transmission device related to a first exemplary embodiment of the invention,

FIG. 2 is a drawing explaining a reception operation of the optical transmission device related to the first exemplary embodiment of the invention,

FIG. 3 is a drawing explaining a transmission operation of the optical transmission device related to the first exemplary embodiment of the invention,

FIG. 4 is a drawing illustrating a configuration of an optical transmission device related to a second exemplary embodiment of the invention,

FIG. 5 is a drawing illustrating a configuration of an optical transmission device related to a third exemplary embodiment of the invention,

FIG. 6 is a drawing illustrating a configuration of a common optical transmission device.

### EXPLANATION OF REFERENCE NUMERALS

110, 110a-110d optical add/drop multiplexing unit
111 optical coupler
112 WSS for dropping
113 WSS for adding
120 aggregator
130 reception unit
131 merging unit
132, 142 optical switch
140 transmission unit
141 branching unit
150 wavelength selection filter
160, 180 transponder
190, 190a-190d, 190A amplifier
191, 191a, 191b, 191c amplifier
191A, 191Aa, 191Ab, 191Ac amplifier
200, 200a, 200b, 200c amplifier
201, 201a, 201b, 201c amplifier
201A, 201Aa, 201Ab, 201Ac amplifier
510 wavelength selection unit
520, 520a, 520b, 520c amplifier
1000, 2000, 5000 optical transmission device

### MODE FOR CARRYING OUT THE INVENTION

### First Exemplary Embodiment

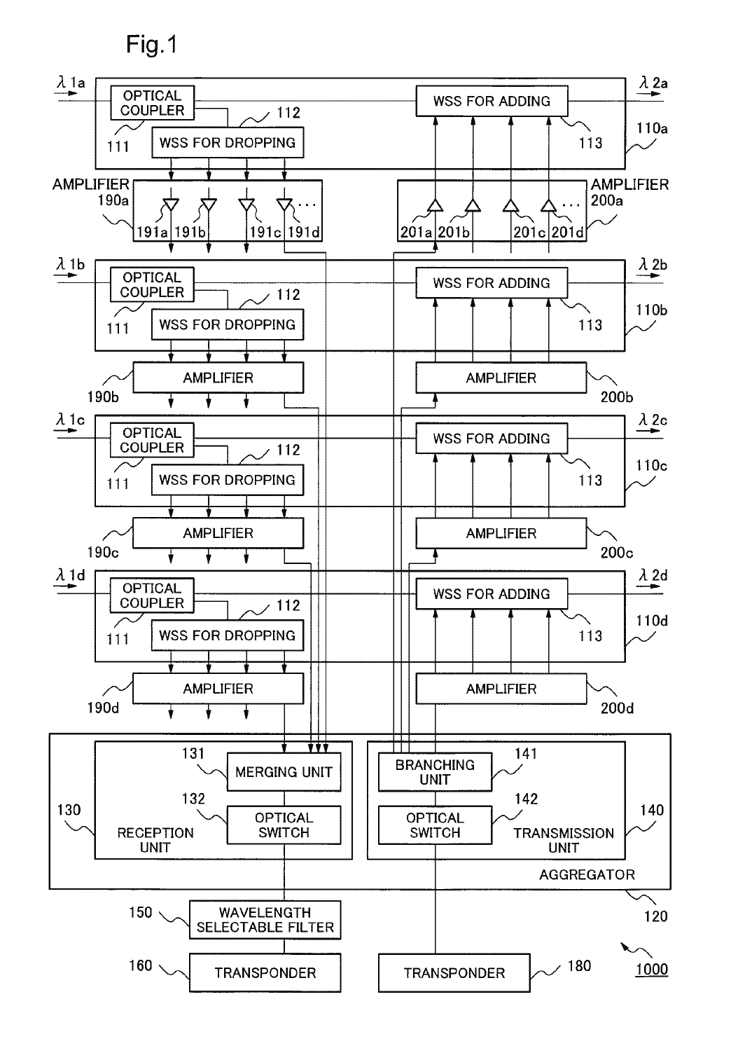

FIG. 1 illustrates a configuration of an optical transmission device related to a first exemplary embodiment of the invention. As shown in FIG. 1, an optical transmission device 1000 includes a plurality of optical add/drop multiplexing units 110a to 110d, an aggregator 120, a wavelength selection filter 150, transponders 160, 180, amplifiers 190a to 190d, 200a to 200d. FIG. 1 exemplifies the optical transmission device 1000 having four optical add/drop multiplexing units. However, the optical transmission device 1000 may include four, less than four, or more than four optical add/drop multiplexing units.

Optical signals, which are WDM signals, λ1a, λ1b, λ1c, and λ1d enter the optical add/drop multiplexing units 110a-110d, and optical signals λ2a, λ2b, λ2c, and λ2d are outputted therefrom, respectively. In below descriptions, if it is not necessary to separately explain each of the optical add/drop multiplexing units 110a to 110d, these are collectively referred to as “optical add/drop multiplexing units 110”. The amplifiers 190a to 190d, 200a to 200d are collectively referred to as “amplifiers 190, 200”. Also, the optical signals λ1a to λ1d are collectively referred to as “optical signal λ1”, and the optical signals λ2a to λ2d are collectively referred to as “optical signal λ2”.

Each of the amplifiers 190a to 190d includes amplifiers 191a, 191b, 191c . . . . Also, each of the amplifiers 200a to 200d includes amplifiers 201a, 201b, 201c . . . . If it is not necessary to separately explain each of the amplifiers 191a, 191b, 191c . . . , and each of the amplifiers 201a, 201b, 201c . . . , these are collectively referred to as “amplifier 191”, and “amplifier 201”, respectively. At least one amplifier 191 and at least one amplifier 201 are needed.

The optical add/drop multiplexing units 110 selects and outputs, as a drop optical signal, any given wavelength of optical signal from an inputted optical signal. The optical add/drop multiplexing units 110 further outputs a multiplexed optical signal in which an add signal is multiplexed to the optical signal in which the drop signal is removed from the inputted optical signal.

The optical add/drop multiplexing units 110 includes an optical coupler 111, a wavelength selectable switch for dropping 112, and a wavelength selectable switch for adding 113. Hereinafter, the wavelength selectable switch for dropping 112 is referred to as “WSS for dropping 112”, and the wavelength selectable switch for adding 113 is referred to as “WSS for adding 113”. Each of the optical couplers 111 in the optical add/drop multiplexing units 110a-110d is connected to all of the WSSs for adding 113 in the optical add-drop multiplexing units 110a-110d. Thereby, each of the optical add-drop multiplexing units 110a-110d includes a wavelength cross-connect function.

The optical coupler 111 branches the inputted optical signal λ1. The WSS for dropping 112 selects, as the drop signal, any given wavelength of optical signal from the optical signal λ1 branched by the optical coupler 111 and outputs the drop signal to the amplifier 190. At this time, the WSS for dropping 112 selects the number of wavelengths of drop signals corresponding to the number of amplifiers 191, and outputs the selected drop signals to each amplifier 191 in the amplifier 190 at each wavelength. The WSS for adding 113 outputs the optical signal in which the add signal inputted from a transmission unit 140 through the amplifier 200 is multiplexed to the optical signal in which the drop signals is removed from the optical signal λ1 branched by the optical coupler 111. The WSS for dropping 112 corresponds to the wavelength selection unit or the first wavelength selection unit of the invention, and the WSS for adding 113 corresponds to the second wavelength selection unit of the invention.

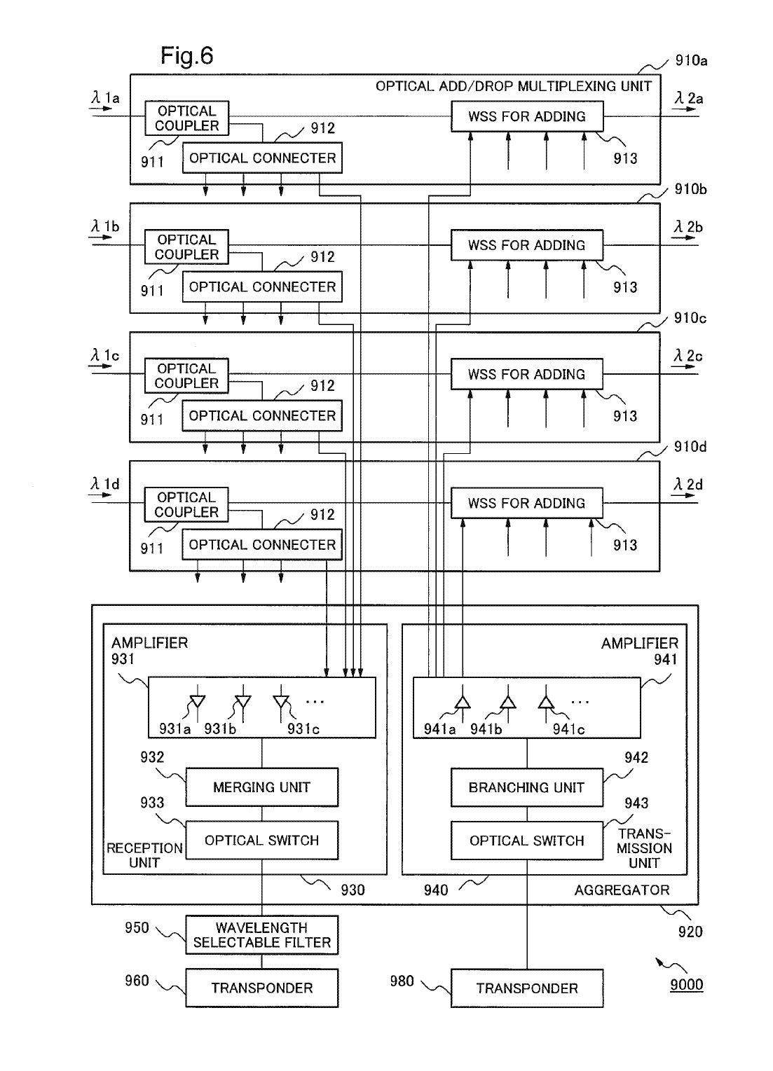

The amplifier 190 amplifies the drop signals outputted by the WSS for dropping 112. The amplifier 191 amplifies the drop signal at each wavelength. The total number of the amplifiers 191 is set lower than the number of wavelengths of the inputted optical signal λ1. In the optical transmission device 9000 illustrated in FIG. 6, the number of amplifiers 931 in the amplifier 931 is set to correspond to the number of wavelength of the inputted optical signal λ1. In the optical transmission device 1000, since the total number of the amplifiers 191 is set lower than the number of wavelengths of the inputted optical signal λ1, the number of the amplifiers 191 can be reduced compared with the optical transmission device 9000 shown in FIG. 6. That is, since corresponding to the number of the amplifiers 191, the total number of wavelengths of the drop signals inputted from the WSS for dropping 112 to each of the amplifiers 191 is reduced compared with the number of wavelength of the inputted optical signal λ1.

The aggregator 120 includes a reception unit 130 and the transmission unit 140. The reception unit 130 receives the drop signals amplified by the amplifier 190. The reception unit 130 includes a merging unit 131 and an optical switch 132. The merging unit 131 merges the drop signals received by the reception unit 130. The merging unit 131 is configured to operate the optical coupler as a merging coupler. The optical switch 132 selects any given signal from the drop signals merged by the merging unit 131 and outputs the signal to the wavelength selection filter 150.

The transmission unit 140 generates the add signal using a signal inputted from the transponder 180 described below, and inputs the add signal to the WSS for adding 113 through the amplifier 200. The transmission unit 140 includes a branching unit 141 and an optical switch 142. The optical switch 142 selects a route of a signal inputted from the transponder 180, and outputs this to the branching unit 141 depending on the selection result. The branching unit 141 branches the inputted signal and outputs this, as the add signal, to the WSS for adding 113 through the amplifier 200 described below. The branching unit 141 is, for example, configured by operating the optical coupler as a splitter.

The wavelength selection filter 150 selects a signal with a specific wavelength in the signals outputted by the optical switch 132. The wavelength selection filter 150 may be either a variable type or a fixed type.

The transponders 160, 180 are connected to a client network, for example. The transponders 160, 180 work as a mutual converter for mutually converting an optical signal of a client side and an optical signal of a WDM side. The transponders 160, 180 are utilized in order to relay and transmit received signals to the client network side and in order to input some signals to the inside of the optical transmission device 1000.

The amplifier 200 amplifies the signal outputted from the branching unit 141 of the transmission unit 140, and inputs the signal to the WSS for adding 113. The amplifier 201 amplifies the add signal inputted from the branching unit 141 at each wavelength.

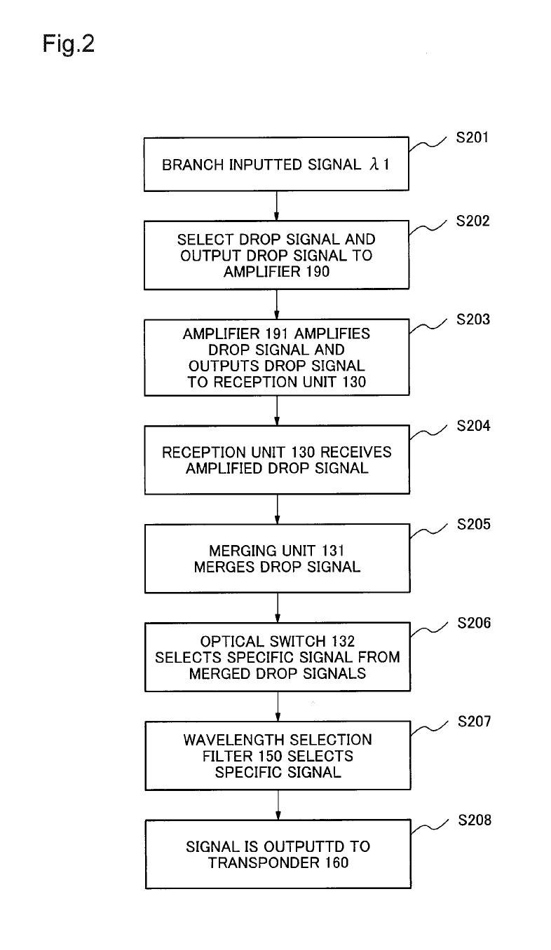

A reception operation of the optical transmission device 1000 related to the first exemplary embodiment of the invention is described based on FIG. 2. The inputted signal is the optical signal that is compliant with ITU-TG.694.1. In FIG. 1, each of the optical signals λ1a, λ1b, λ1c, and λ1d which enter the optical add/drop multiplexing units 110a to 110d respectively, includes 96 waves and ranges from 1530 nm to 1560 nm. The wavelength and the number of the wavelengths described below are examples, and the invention is not limited to these.

As shown in FIG. 2, the optical coupler 111 initially branches the inputted optical signal λ1 (S201).

The WSS for dropping 112 selects, as the drop signal, any given wavelength of optical signal from the optical signal λ1 branched by the optical coupler 111, and outputs the drop signal to the amplifier 190 (S202). The WSS for dropping 112 selects the number of wavelengths of the drop signals corresponding to the number of the amplifiers 191 and outputs the selected drop signals to each amplifier 191 in the amplifier 190 at each wavelength. For example, if each of the amplifiers 190a to 190d includes four amplifiers 191, the WSS for dropping 112 outputs, depending on the number of the amplifiers 191, the drop signals having up to 24 waves (=96 waves/4) to four amplifiers 191. The 24 waves outputted from the same port in the WSS for dropping 112 are arbitrarily selectable.

Each amplifier 191 in the amplifier 190 amplifies the drop signal at each wavelength and outputs this to the reception unit 130 (S203). In the example above described, each amplifier 191 amplifies the arbitrary 24 waves selected by the WSS 112.

The reception unit 130 receives the amplified drop signals (S204). In the reception unit 130, the merging unit 131 merges the drop signals (S205), and the optical switch 132 selects an arbitrary signal from the merged drop signals (S206) and outputs this to the wavelength selection filter 150. The wavelength selection filter 150 selects the signal with the specific wavelength from the signals outputted by the optical switch 132 (S207). After that, the drop signal whose wavelength is specified is outputted to the transponder 160 (S208).

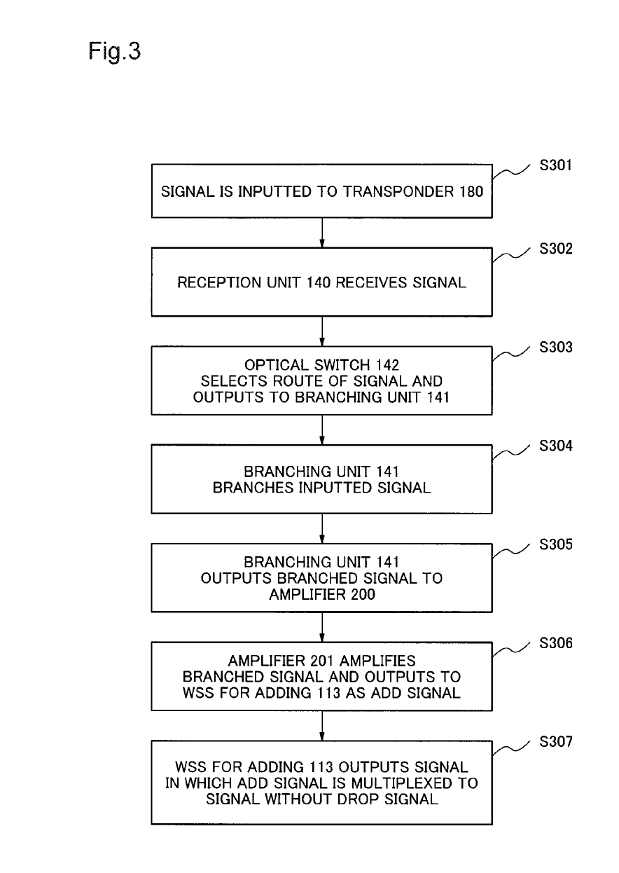

Next, a transmission operation of the optical transmission device 1000 related to the first exemplary embodiment of the invention is described based on FIG. 3. When a signal is inputted from a network side to the transponder 180 (S301), the transponder 180 inputs the signal to the transmission unit 140. When the transmission unit 140 receives the signal (S302), the optical switch 142 in the transmission unit 140 selects a route of the signal and outputs this to the branching unit 141 depending on the selection result (S303). The branching unit 141 branches the inputted signal (S304), and outputs to the amplifier 200 (S305). Each amplifier 201 in the amplifier 200 amplifies the signal outputted from the branching unit 141 at each wavelength, and outputs this to the WSS for adding 113 as the add signal (S306). The WSS for adding 113 outputs the optical signal in which the add signal is multiplexed to the optical signal in which the drop signals is removed from the inputted signal (S307).

As described above, the optical transmission device related to the first exemplary embodiment of the invention includes the wavelength selection unit (e.g. WSS for dropping 112 in FIG. 1) and the amplifier (e.g. amplifier 191 in FIG. 1). The wavelength selection unit selects and outputs, as the drop signal, any given wavelength of optical signal from the input optical signal (e.g. λ1a, λ1b, λ1c, and λ1d). The amplifier amplifies the drop signals outputted by the wavelength selection unit at each wavelength. The number of the amplifiers is set lower than the number of wavelengths of the inputted optical signal λ1. The wavelength selection unit selects the number of wavelengths of drop signals corresponding to the number of amplifiers, and outputs these to the amplifiers at each wavelength.

Since the number of the amplifiers is set lower than the number of wavelengths of the inputted optical signal, the number of the amplifiers can be reduced. At the time, since the wavelength selection unit selects the number of wavelengths of drop signals corresponding to the number of the amplifiers and outputs the selected drop signals to the amplifiers at each wavelength, output corresponding to the number of the amplifiers can be obtained. Total output of the amplifiers 191 in the optical transmission device is calculated by multiplying the number of the amplifiers by output of each amplifier. Since the number of amplifiers is reduced, the maximum output of the optical transmission device can be reduced. Accordingly, total power consumption in the optical transmission device can be reduced, a mechanism for releasing heat of the amplifier 191 can be simplified, and the optical transmission device can be reduced. Since the mechanism for release of heat can be simplified and parts for release of heat can be reduced, the price of the optical transmission device can be dropped.

The optical transmission device related to the first exemplary embodiment of the invention includes the reception unit (e.g. reception unit 130 in FIG. 1) for receiving the drop signal amplified by the amplifier (e.g. amplifier 191 in FIG. 1). The optical transmission device related to the exemplary embodiment can be configured without the reception unit. However, placing the reception unit, the optical transmission unit can include a function to receive the drop signals.

In the optical transmission device related to the first exemplary embodiment of the invention, the transponder (e.g. transponder 160 in FIG. 1) is connected to the reception unit (e.g. reception unit 130 in FIG. 1). The wavelength selection filter (e.g. wavelength selection filter 150 in FIG. 1) is arranged between the transponder and the reception unit. The wavelength selection filter can select a specific wavelength from the drop signals which is inputted to the reception unit while changing the specific wavelength. The optical transmission device of the exemplary embodiment can be configured without the wavelength selection filter. However, if the wavelength selection filter is further arranged, any given wavelength may be selected in a wider range using both the wavelength selection unit and the wavelength selection filter. Thereby, any given wavelength may be allocated to each of the drop side outputs, in particular. As a result, colorless can be achieved in the sense that an allocated wavelength is arbitrary and is not limited.

In the optical transmission device related to the first exemplary embodiment of the invention, the transponder (e.g. transponder 160 in FIG. 1) is connected to the reception unit (e.g. reception unit 130 in FIG. 1). The transponder may be the coherent type transponder.

In a common optical transmission device, selecting one intended wavelength, a transponder needs a wavelength selection filter between a reception unit and the transponder. If the transponder is the coherent type transponder, the transponder itself includes a wavelength selection function and does not require a wavelength variable filter. Thereby a cost for the wavelength variable filter can be cut and loss of the wavelength variable filter can be reduced. A reception wavelength can be selected as an oscillation frequency of a local oscillator installed in the transponder (LO-SELECTION). If LO-SELECTION is selected, the more the number of wavelengths which are inputted to the reception unit becomes, the lower the optical SNR (signal-noise ratio) resistance becomes, and every wavelength except the one intended wavelength becomes noise. Therefore, if the wavelength selection unit restricts the number of wavelengths which are inputted to the reception unit, it is possible to improve the optical SNR resistance. As a result, transmission characteristics, like the maximum transmission distance, are improved.

In the optical transmission device related to the first exemplary embodiment of the invention, the optical switch (e.g. optical switch 132 in FIG. 1) is arranged in the reception unit (e.g. reception unit 130). The optical switch selects any given signal from the drop signals. The optical transmission device of the exemplary embodiment can be configured without the optical switch. On the other hand, input to the transponder can be associated with any given route if the optical switch is installed. Specifically, the drop signals can be inputted to the reception unit through any given four transmission routes from the wavelength selection unit. In the light of the reception unit side, the reception unit can receive the drop signal through any one of the four transmission routes. As a result, directionless is achieved in the sense that the route can be arbitrarily set.

In the optical transmission device related to the first exemplary embodiment of the invention, the reception unit (e.g. reception unit 130) includes the merging unit for merging the drop signals (e.g. merging unit 131) in addition to the optical switch (e.g. optical switch 132 in FIG. 1). The optical transmission device of the exemplary embodiment can be configured without the merging unit. In a common optical transmission device, the problem is that one reception unit cannot deal with optical signals with the same wavelength which are inputted from different routes. If the optical switch and the merging unit are installed, the optical switch can select any given signal and the merging unit can merge the drop signals. Therefore, the optical signals with the same wavelength which are inputted from different routes can be received by the same reception unit. Contentionless is achieved in the sense that restriction of the common optical transmission device is removed.

In the optical transmission device related to the first exemplary embodiment of the invention, the second wavelength selection unit (e.g. WSS for adding 113 in FIG. 1) is included separately from the wavelength selection unit (e.g. WSS for dropping 112 in FIG. 1). The optical transmission device further includes the transmission unit (e.g. transmission unit 140). The second wavelength selection unit outputs the optical signal in which the add signal is multiplexed to the optical signal in which the drop signals is removed from the inputted signal. The transmission unit generates the add signal and inputs the add signal to the second wavelength selection unit. The optical transmission device of the exemplary embodiment can be configured without the second wavelength selection unit. On the other hand, if the second wavelength selection unit is arranged, the transmission side configuration can be included to the optical transmission device. At this time, parts can be shared, for example, by setting the second wavelength selection unit as the same configuration as the wavelength selection unit.

In the optical transmission device, if colorless, directionless, and contentionless as described above are achieved, it becomes unnecessary to prepare a reserve transponder for each wavelength of the optical signal and for each route thereof, when redundant configuration has to be formed in preparation for transponder failure. When one or more reserve transponders are prepared for the actually-used transponder, the reserve transponders can be functioned as the redundant transponder, regardless of routes and wavelengths.

### Second Exemplary Embodiment

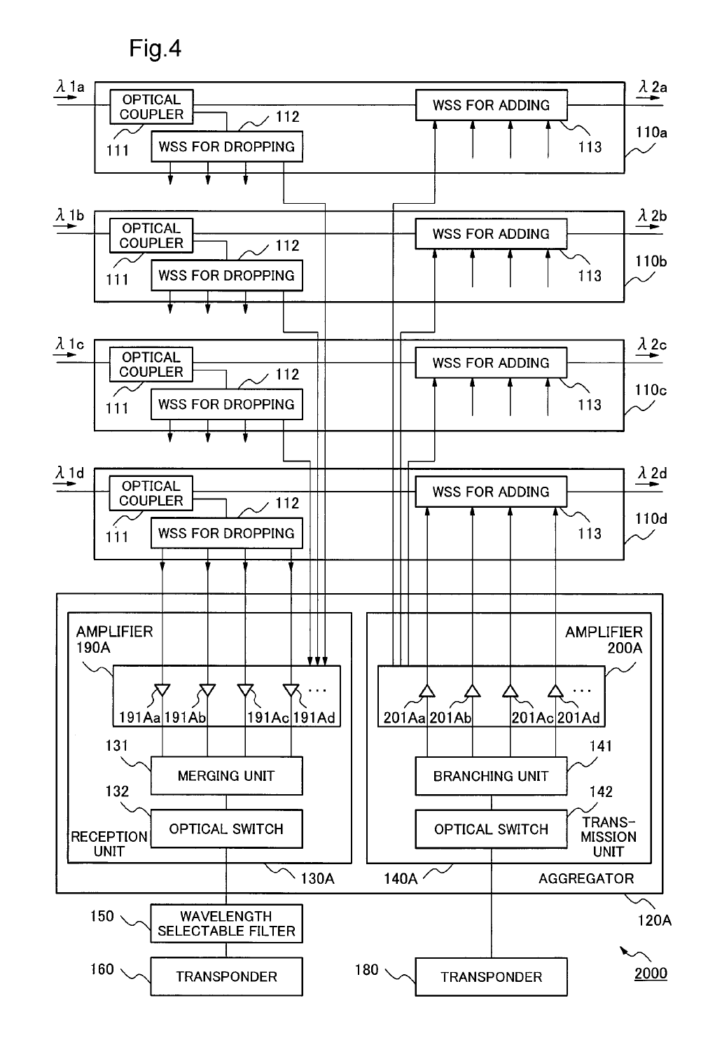

FIG. 4 illustrates a configuration of an optical transmission device related to a second exemplary embodiment of the invention. As shown in FIG. 4, an optical transmission device 2000 includes the plurality of optical add/drop multiplexing units 110, an aggregator 120A, the wavelength selection filter 150, the transponders 160, 180.

The second exemplary embodiment is compared with the first exemplary embodiment. The amplifiers 190, 200 are arranged between the optical add/drop multiplexing unit 110 and the aggregator 120 in the first exemplary embodiment. In contrast, and amplifiers 190A, 200A are arranged inside a reception unit 130A of the aggregator 120A and a transmission unit 140A thereof, respectively, in the second exemplary embodiment.

As shown in FIG. 4, the reception unit 130A includes the amplifiers 190A, and the transmission unit 140A includes the amplifiers 200A. The amplifier 190A includes amplifiers 191Aa, 191Ab, 191Ac, 191Ad . . . . The amplifier 200A includes amplifiers 201Aa, 201Ab, 201Ac . . . . If it is not necessary to separately explain the amplifiers 191Aa, 191Ab, 191Ac, 191Ad . . . and the amplifiers 201Aa, 201Ab, 201Ac . . . , the amplifiers are collectively referred to as “the amplifier 191A” and “the amplifier 201A”, respectively.

In the first exemplary embodiment, the amplifier 190 is disposed at each WSS for dropping 112. In contrast, in the second exemplary embodiment, the drop signals outputted from all the WSSs for dropping 112 enter the amplifier 190A. The amplifier 190 A amplifies all the drop signals inputted from the WSSs for dropping 112. The number of the amplifiers 191A in the amplifier 190A is set lower than the number of wavelengths of the inputted optical signal λ1. The WSSs for dropping 112 select the number of wavelengths of the drop signals corresponding to the number of the amplifiers 191A, and outputs the selected drop signals to each amplifier 191 in the amplifier 190A at each wavelength. Each of the amplifiers 191A amplifies the drop signal at each wavelength.

In the first exemplary embodiment, the amplifier 200 is disposed at each WSS for adding 113. In contrast, in the second exemplary embodiment, signals which are outputted to all the WSSs for adding 113 enter the amplifier 200A. The amplifier 200A amplifies the signals.

As described above, according to the optical transmission device related to the second exemplary embodiment of the invention, the amplifier (e.g. amplifier 191A in FIG. 4) is arranged inside the reception unit (e.g. reception unit 130A in FIG. 4). As described in the exemplary embodiment, the amplifier is not necessarily arranged inside the reception unit. On the other hand, by arranging the amplifier inside the reception unit, the amplifier can be structurally included inside the reception unit, and an amplification function can be installed inside the reception unit.

### Third Exemplary Embodiment

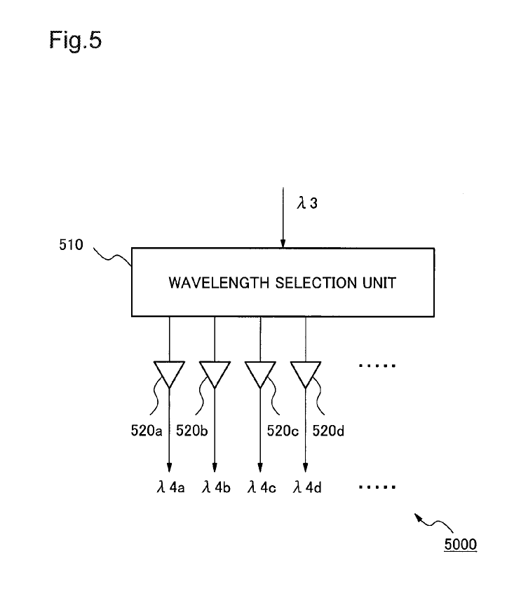

FIG. 5 illustrates a configuration of an optical transmission device related to a third exemplary embodiment of the invention. As illustrated in FIG. 5, an optical transmission device 5000 includes a wavelength selection unit 510 and amplifiers 520a, 520b, 520c . . . . If it is not necessary to separately explain the amplifiers 520a, 520b, 520c . . . , the amplifiers are collectively referred to as “amplifier 520”. The amplifier 520 has to be one or more, and is not limited to the example in FIG. 5.

The wavelength selection unit 510 selects and outputs, as a drop signal, any given wavelength of optical signal from an inputted optical signal λ3. Each of the amplifiers 520 is connected to the wavelength selection unit 510. The amplifiers 520 amplifies the drop signals outputted from the wavelength selection unit 510 at each wavelength, and output the amplified drop signals λ4a, λ4b, λ4c . . . .

The number of the amplifiers 520 is set lower than the number of wavelengths of inputted optical signal λ4. The wavelength selection unit 510 selects the number of wavelength of the drop signals corresponding to the number of the amplifiers 520, and outputs the selected drop signals to the amplifiers 520 at each wavelength.

Since the number of the amplifiers 520 is set lower than the number of wavelengths of the inputted optical signal λ4, the number of the amplifiers 520 can be reduced. Thereby, since the number of the amplifiers 520 can be reduced, the maximum output of the optical transmission device 5000 can be reduced.

While having described an invention of the present application referring to the embodiments, the invention of the present application is not limited to the above mentioned embodiments. It is to be understood that to the configurations and details of the invention of the present application, various changes can be made within the scope of the invention of the present application by those skilled in the art. A part or all of the above exemplary embodiments may be described as following supplemental notes, however is not limited to the following.

In the descriptions of the exemplary embodiments, the WSS for adding 113 is configured using the wavelength selectable switch. An optical splitter, however, can be used instead thereof. Since the number of wavelength inputted in the amplifier 200 on the transmission side corresponds to the number of the transponders 180 connected to the aggregator 120, the maximum number of wavelengths does not exceed the number of the transponders 180 connected to the aggregator 120. It is, therefore, less effective in the transmission side in limiting the number of wavelengths in the WSS for adding 113, compared with the reception side in which the number of inputted wavelengths is uncertain.

This application claims priority from Japanese Patent Application No. 2011-026257 filed on Feb. 9, 2011, the contents of which are incorporation herein by reference in their entirety.

### INDUSTRIAL APPLICABILITY

The invention is applicable to an optical transmission device for adding/dropping an optical signal and changing a direction thereof, for example, in an optical network.

1. An optical transmission device, comprising:
a wavelength selection unit which selects and outputs, as a drop signal, any given wavelength of optical signal from an input optical signal; and
an amplifier which amplifies the drop signal output by the wavelength selection unit at each wavelength,
wherein the number of amplifiers is set lower than the number of wavelengths of the input optical signal, and the wavelength selection unit selects a number of wavelengths of drop signals corresponding to the number of amplifiers, and outputs the selected drop signals to the amplifiers at each wavelength.

2. The optical transmission device of claim 1, further comprising a reception unit which receives the drop signal amplified by the amplifier.

3. The optical transmission device of claim 2, wherein the amplifier is arranged in the reception unit.

4. The optical transmission device of claim 2, wherein a transponder is connected to the reception unit and, a wavelength selection filter is arranged between the transponder and the reception unit, the wavelength selection filter being capable of selecting a specific wavelength from the drop signal that is inputted in the reception unit while changing the specific wavelength.

5. The optical transmission device of claim 2, wherein a transponder is connected to the reception unit, the transponder being a coherent system transponder.

6. The optical transmission device of claim 2, wherein the reception unit includes an optical switch which selects any given signal from the drop signal.

7. The optical transmission device of claim 6, wherein the reception unit further includes a merging unit which merges the drop signal.

8. The optical transmission device of claim 2, further comprising:
a second wavelength selection unit which outputs an optical signal in which an add signal is multiplexed to an optical signal in which the drop signal is removed from the input signal; and
a transmission unit which generates the add signal and inputting the add signal into the second wavelength selection unit.
